(19) United States
(12) Patent Application Publication
(10) Pub. No.: US 2018/0053218 A1
(43) Pub. Date: Feb. 22, 2018

(54) TARGETING OPTIMIZATION BY BLOCKING ADVERTISEMENTS FOR ALREADY PERFORMED CONVERSION EVENTS

(71) Applicant: Facebook, Inc., Menlo Park, CA (US)

(72) Inventors: Aman Preet Singh, Sammamish, WA (US); Aliasgar Mumtaz Husain, Milpitas, CA (US)

(21) Appl. No.: 15/243,693

(22) Filed: Aug. 22, 2016

(51) Int. Cl. G06Q 30/02; G06Q 50/00

(52) U.S. Cl. CPC G06Q 30/0269; G06Q 50/01; G06Q 30/0246

(57) ABSTRACT

Information for an advertising campaign received by an online system includes one or more advertisements for presentation to one or more users of the online system, and specifies at least one conversion event for the one or more advertisements in the ad campaign. An advertisement is selected from the advertising campaign as a candidate advertisement for presentation to a viewing user of the online system. The online system obtains information that that the viewing user performed a conversion event specified in the ad campaign. Responsive to determining that the viewing user performed the conversion event specified in the ad campaign, the online system blocks the selected candidate advertisement from being eligible for presentation to the viewing user.

### BACKGROUND

This disclosure relates generally to delivery of advertisements to online system users, and more specifically to targeting optimization by blocking advertisements for already performed conversion events specified in an advertising campaign.

Online services, such as social networking systems, search engines, news aggregators, Internet shopping services, and content delivery services, have become a popular venue for presenting advertisements to prospective buyers. The online services may generate revenue by presenting advertisements to users, who may take certain actions based on the presented advertisements (e.g., clicking on the advertisements or purchasing products presented in the advertisements). The advertisement-based online service model has spawned many diverse types of online services.

An online system, such as a social networking system, allows its users to connect to and communicate with other online system users. Users may create profiles on an online system that are tied to their identities and include information about the users, such as interests and demographic information. The users may be individuals or entities such as corporations or charities. Because of the increasing popularity of online systems and the increasing amount of user-specific information maintained by online systems, an online system provides an ideal forum for entities to increase awareness about products or services by presenting content items to online system users.

Presenting content items to online system users allows an entity to gain public attention for products or services or to persuade online system users to take an action regarding the entity's products or services. Additionally, many online systems generate revenue by displaying certain content items to their users. Frequently, online systems charge entities for each presentation of certain types of content items to an online system user (e.g., each “impression” of the certain types of content items) or for each interaction with certain types of content items by an online system user. The display of an advertisement to a viewer of the advertisement is referred to herein as an advertising “impression.”

An advertising system can allow advertisers to target specific online system users with advertisements based on available information related to users' interests, i.e., based on information that the online system users have previously shown certain interests in conversion events specified in the advertisements, such as information about visiting web pages related to products presented in the advertisements. It is however desirable to block an advertisement from being eligible for presentation to an online system user who has already performed a conversion event specified in the advertisement, such as purchasing a product advertised in the advertisement.

### SUMMARY

An online system, such as a social networking system, receives information for an advertising campaign including one or more advertisements for presentation to one or more users of an online system, the information specifying at least one conversion event for the one or more advertisements in the advertising campaign. The online system selects an advertisement from the advertising campaign as a candidate advertisement for presentation to a viewing user of the online system. The online systems selects the candidate advertisement based on the viewing user having seen at least a part of a content related to at least one product associated with the advertising campaign. The online system obtains information that the viewing user performed a conversion event specified in the advertising campaign. The online system can self-aggregate the information about the conversion event and the information about the viewing user. Alternatively, the online system can receive the aggregated information about the conversion event from another service entity. In response to determining that the viewing user performed the conversion event specified in the advertising campaign, the online system blocks the selected candidate advertisement from being eligible for presentation to the viewing user.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for targeting optimization by blocking advertisements for already performed conversion events, in accordance with an embodiment.

FIG. 4 illustrates a process flow diagram of different mechanisms for reporting of already performed conversion events, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

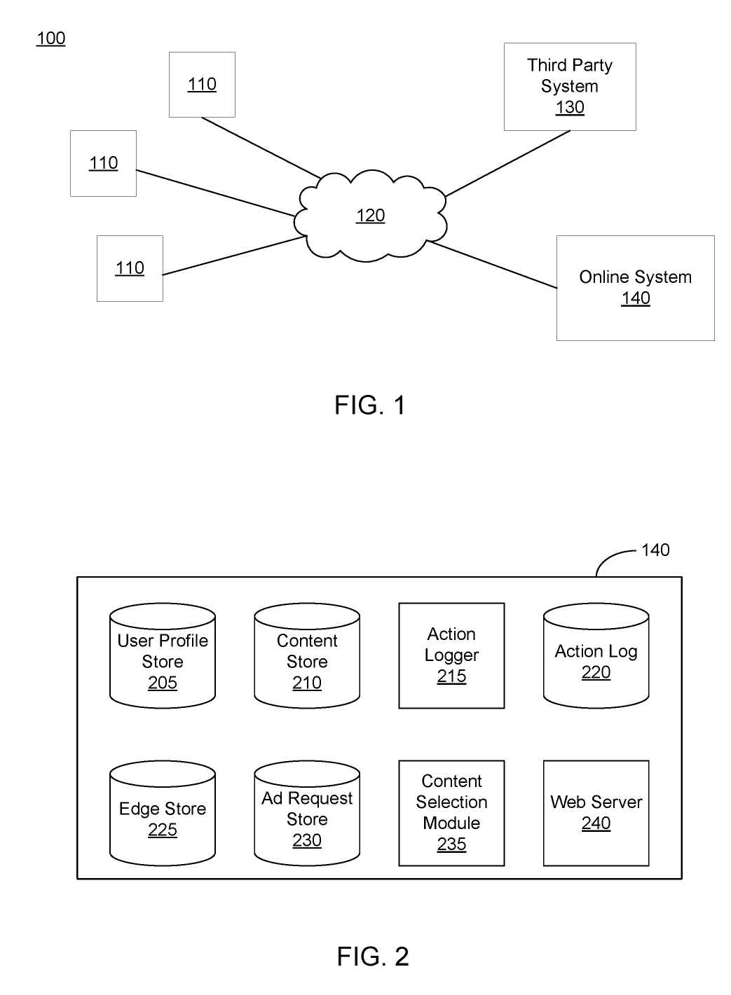

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein may be adapted to online systems that are social networking systems, content sharing networks, or other systems providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as advertisements, content, or information about an application provided by the third party system 130.

In some embodiments, one or more of the third party systems 130 provide content to the online system 140 for presentation to users of the online system 140 and provide compensation to the online system 140 in exchange for presenting the content. For example, a third party system 130 provides advertisement requests, which are further described below in conjunction with FIG. 2, including advertisements for presentation and amounts of compensation provided by the third party system 130 to the online system 140 in exchange for presenting the advertisements to the online system 140. Content presented by the online system 140 for which the online system 140 receives compensation in exchange for presenting is referred to herein as “sponsored content,” “sponsored content items,” or “advertisements.” Sponsored content from a third party system 130 may be associated with the third party system 130 or with another entity on whose behalf the third party system 130 operates.

FIG. 2 is a block diagram of an architecture of the online system 140. The online system 140 shown in FIG. 2 includes a user profile store 205, a content store 210, an action logger 215, an action log 220, an edge store 225, an advertisement (“ad”) request store 230, a content selection module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged and stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity. In some embodiments, the brand page associated with the entity's user profile may retrieve information from one or more user profiles associated with users who have interacted with the brand page or with other content associated with the entity, allowing the brand page to include information personalized to a user when presented to the user.

The content store 210 stores objects that each represents various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), engaging in a transaction, viewing an object (e.g., a content item), and sharing an object (e.g., a content item) with another user . Additionally, the action log 220 may record a user's interactions with advertisements on the online system 140 as well as with other applications operating on the online system 140. In some embodiments, data from the action log 220 is used to infer interests or preferences of a user, augmenting the interests included in the user's profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or a particular user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent applicatio Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. In various embodiments, the ad request store 230 includes one or more ad requests, each ad request representing a request from an advertiser (e.g., the third party system 130) to serve an advertisement to one or more users of the online system 140 during an advertising campaign (“ad campaign”). An ad campaign includes one or more advertisements for presentation to one or more users of the online system 140. The ad campaign may be associated with one or more objectives, a budget and duration. An objective associated with an ad campaign describes one or more goals for presentation of advertisements during the ad campaign. For example, an objective specifies a total number of impressions of advertisements to be delivered to the users of the online system 140 under the ad campaign during a time interval of the ad campaign. The budget specifies a total amount of compensation a user (e.g., an advertiser) associated with an ad campaign provides the online system 140 for presenting advertisements to the users of the online system 140.

Additionally, the duration associated with the ad campaign specifies a time interval during which advertisements are presented to social networking system users. For example, if the duration of an ad campaign is 30 days, advertisements included in the ad campaign are presented to online system users for 30 days after the ad campaign is provided to the online system 140. In some embodiments, the user providing the ad campaign may also specify a start date for the ad campaign, so the duration is measured from the specified start date.

An ad campaign includes one or more advertisements for presentation to one or more social networking system users. An advertisement includes advertisement content and a bid amount. The advertisement is text, image, audio, video, or any other suitable data presented to a user. The advertisement may also include a landing page specifying a network address to which a user is directed when the advertisement content is accessed. In some embodiments, the bid amount is associated with an advertisement by a user providing the advertisement to the online system 140 and is used to determine an expected value, such as monetary compensation, provided by the user to the online system 140 if the advertisement is presented to another user, if the advertisement receives an interaction from another user presented with the advertisement, or if any suitable condition is satisfied when the advertisement is presented to another user. For example, the bid amount specifies a monetary amount that the online system 140 receives from an advertiser if an advertisement is displayed. In some embodiments, the expected value to the online system 140 of presenting the advertisement may be determined by multiplying the bid amount by a probability of the advertisement being accessed by a user.

Alternatively, the user providing an advertisement to the online system 140 does not associate a bid amount with the advertisement, but the online system 140 determines a bid amount for the advertisement based on a budget, a duration, or an objective associated with the ad campaign including the advertisement. For example, a pacing factor is determined from the budget associated with an ad campaign including the advertisement and an amount spent by an advertiser on the ad campaign from a start date of the ad campaign to a current time. The pacing factor modifies a bid amount associated with various advertisements in the ad campaign, altering spending of the ad campaign's budget throughout the duration of the ad campaign.

Additionally, an advertisement may include one or more targeting criteria specified by the user providing the advertisement to the online system 140 (e.g., advertiser). Targeting criteria included in an advertisement specify one or more characteristics of users eligible to be presented with advertisement content in the advertisement. For example, targeting criteria are used to identify users having user profile information, edges, or actions satisfying at least one of the targeting criteria. Hence, targeting criteria allow a user to identify other users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users who have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows further refinement of users eligible to be presented with an advertisement. As another example, targeting criteria identifies users having a connection to another user or object or having a particular type of connection to another user or object.

The content selection module 235 selects one or more content items for communication to a client device 110 to be presented to a user. Content items eligible for presentation to the user are retrieved from the content store 210, from the ad request store 230, or from another source by the content selection module 235, which selects one or more of the content items for presentation to the user. A content item eligible for presentation to the user may be a content item associated with at least a threshold number of targeting criteria satisfied by characteristics of the user or is a content item that is not associated with targeting criteria. In various embodiments, the content selection module 235 includes content items eligible for presentation to the user in one or more selection processes, which identify a set of content items for presentation to the user. For example, the content selection module 235 determines measures of relevance of various content items to the user based on characteristics associated with the user by the online system 140, based on the user's affinity for different content items, and/or based on inferred hobbies and interests of the user. Information associated with the user included in the user profile store 205, in the action log 220, and in the edge store 225 may be used to determine the measures of relevance and to infer the user's hobbies/interests. Based on the measures of relevance and the inferred user's hobbies/interests, the content selection module 235 selects content items for presentation to the user. As an additional example, the content selection module 235 selects content items having the highest measures of relevance or having at least a threshold measure of relevance for presentation to the user. Alternatively, the content selection module 235 ranks content items based on their associated measures of relevance and selects content items having the highest positions in the ranking or having at least a threshold position in the ranking for presentation to the user.

Content items selected for presentation to the user may include advertisements or other content items associated with bid amounts. The content selection module 235 uses the bid amounts associated with advertisements when selecting content for presentation to the viewing user. In various embodiments, the content selection module 235 determines an expected value associated with various advertisements (or other content items) based on their bid amounts and selects advertisements associated with a maximum expected value or associated with at least a threshold expected value for presentation. An expected value associated with an advertisement or with a content item represents an expected amount of compensation to the online system 140 for presenting an advertisement from for presenting the content item. For example, the expected value associated with an advertisement is a product of the advertisement's bid amount and a likelihood of the user interacting with the advertisement content. The content selection module 235 may rank advertisements based on their associated bid amounts and select advertisements having at least a threshold position in the ranking for presentation to the user. In some embodiments, the content selection module 235 ranks both content items not associated with bid amounts and advertisements in a unified ranking based on bid amounts associated with advertisements and measures of relevance associated with content items and with advertisements. Based on the unified ranking, the content selection module 235 selects content for presentation to the user. Selecting advertisements and other content items through a unified ranking is further described in U.S. patent application Ser. No. 13/545,266, filed on Jul. 10, 2012, which is hereby incorporated by reference in its entirety.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

### Blocking Advertisements for Performed Conversion Events

In various embodiments, it is desirable to avoid sending an advertisement to an online system user that has already performed a conversion event specified in that advertisement. In an embodiment, the conversion event is related to purchasing in the past at least one product presented in the advertisement. In another embodiment, the conversion event is related to purchasing in the past a product of a same type as at least one product presented in the advertisement, i.e., purchasing of a competing product. Disclosed embodiments include a method and an advertising system that controls a publisher of the online system 140 to block presentation of an advertisement to an online system user who has already performed a conversion event specified in the advertisement. In an illustrative embodiment, the online system user viewed an advertisement of a product via a publisher, and then purchased the product either offline (e.g., at a “brick and mortar” store) or online via the same or a different publisher. An advertising system is configured to receive information about purchasing the product in order to block an advertisement that advertises the purchased product from being eligible for presentation to the online system user. In some embodiments, as discussed in more detail below, various mechanisms can be employed to report a conversion event related to purchasing of a product, such as reporting by the online system user itself or reporting by the third party system 130 related to the purchased product (e.g., a merchant that sells the product).

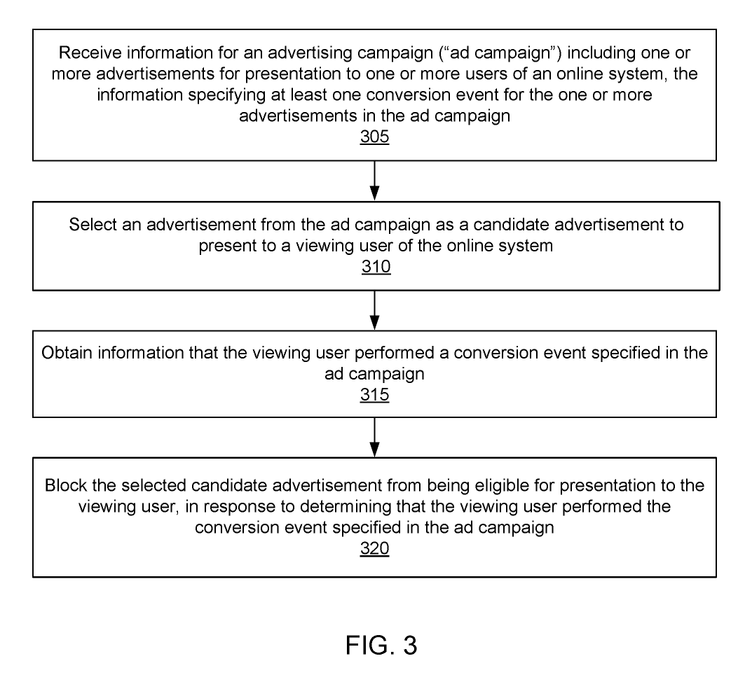

FIG. 3 is a flowchart of one embodiment of a method for targeting optimization by blocking advertisements for already performed conversion events, in accordance with an embodiment. In various embodiments, the steps described in conjunction with FIG. 3 may be performed in different orders than the order described in conjunction with FIG. 3. Additionally, the method may include different and/or additional steps than those described in conjunction with FIG. 3 in some embodiments.

The online system 140 receives 305 information for an advertising campaign (“ad campaign”) including one or more advertisements for presentation to one or more users of the online system 140. In some embodiments, an advertiser provides the information for the ad campaign including the one or more advertisements to the online system 140. The information may specify a budget target for the ad campaign and an objective for the ad campaign that specifies one or more goals for presentation of advertisements from the ad campaign to online system users. Additionally, the information for the ad campaign includes bid amounts associated with one or more advertisements in the ad campaign or instructions for determining bid amounts for advertisements in the ad campaign. For example, the information includes instructions for allocating the budget among advertisements in the ad campaign based on one or more criteria (e.g., an amount of the budget remaining, an amount of the objective that has been completed, an amount of a time interval of the ad campaign remaining, and so on).

In some embodiments, the information for the ad campaign received 305 specifies at least one conversion event for the one or more advertisements in the ad campaign. Each advertisement in the ad campaign may specify at least one conversion event related to purchasing one or more products presented in that advertisement. In an embodiment, the one or more products can be purchased online based on a direct interaction of a viewing user with the advertisement. In another embodiment, a product presented in the advertisement can be purchased offline (e.g., at a “brick and mortar” store) without a direct interaction of a viewing user with the advertisement.

The online system 140 selects 310 an advertisement from the ad campaign as a candidate advertisement for presentation to a viewing user of the online system 140. In some embodiments, the online system 140 selects the candidate advertisement from the ad campaign based on information that the viewing user saw at least a part of a content related to at least one product associated with the ad campaign. Thus, the selected candidate advertisement may represent a retargeting advertisement since the advertisement is selected based on past action(s) of the viewing user. In some embodiments, the online system 140 allows targeting the viewing user with retargeting advertisements based on information about one or more products in which the viewing user has previously shown an interest, such as visiting web pages for products presented in the retargeting advertisements.

In some embodiments, information about the viewing user interacted in the past with a certain content related to at least one product associated with the ad campaign can be generated and obtained by the action log 220 of the online system 140 based on one or more actions of the viewing user in relation to the at least one product associated with the ad campaign. In an embodiment, the content selection module 235 selects 310 the advertisement from the ad campaign as the candidate advertisement for presentation to the viewing user based on the information received from the action log 220.

The online system 140 obtains 315 information that the viewing user performed a conversion event specified in the ad campaign. In an embodiment, the conversion event performed in the past by the viewing user relates to purchasing in the past one or more products presented in the selected candidate advertisement. In another embodiment, the conversion event performed in the past by the viewing user relates to purchasing in the past a competing product to at least one product presented in the selected candidate advertisement. For example, the competing product can be of a same type as the at least one product presented in the selected candidate advertisement.

In some embodiments, the online system 140 receives information about an identity of the viewing user and information about the conversion event. The online system 140 also has knowledge of an identity of a user of the online system to whom an impression will be delivered for presentation of the selected candidate advertisement. Then, the online system 140 can correlate, at a time of impression, the identity of the viewing user with the identity of the user of the online system. Furthermore, the online system 140 can correlate the received information about the conversion event with information about another conversion event specified in the selected candidate advertisement. Based on the correlation results, the online system 140 may determine that the viewing user performed in the past the conversion event specified in the ad campaign and specified in the selected candidate advertisement.

In some embodiments, the online system 140 obtains 315, from an aggregator service, information that the viewing user performed the conversion event. The aggregator service may be the third party system 130 separate from the online system 140 that collects globally unique identifiers of purchased products and identifiers of online system users (e.g., hashed users identifiers) who have purchased the products. In an embodiment, the online system 140 receives, from the aggregator service, information that the viewing user purchased one or more products presented in the selected candidate advertisement. In addition, the online system 140 receives, from the aggregator service, information about the identity of the viewing user. Alternatively, a publisher of the online system 140 may self-aggregate unique identifiers of purchased products as well as identifiers of online system users who have purchased the products. In an embodiment, the publisher obtains 315 the identifiers of the purchased products and the identifiers of the users based on tracking pixels at browser presentations of purchasing confirmation pages. In another embodiment, the publisher obtains 315 the identifiers of the purchased products and the identifiers of the users based on cookies related to purchasing confirmation pages. In yet another embodiment, the publisher obtains 315 the identifiers of the purchased products and the identifiers of the users based on Personally Identifiable Information (PII) related to the online system users who have purchased the products. For example, PII may be available to the publisher based on self-reporting of purchases by the online system users itself In yet another embodiment, the publisher obtains 315 the identifiers of the purchased products and of the users who have purchased the products based on application programming interface (API) interacting with presentations of purchasing confirmations on a mobile application where purchases occur. In yet another embodiment, the publisher obtains 315 the identifiers of the purchased products and of the users who have purchased the products based on browser plug-ins interacting with purchasing confirmation pages.

In some embodiments, the entity reporting the purchase of the product to the online system 140 is the online system user itself. Thus, the online system 140 may receive information about the conversion event (e.g., purchase of product) and information about an identity of the viewing user directly from the viewing user. At a time of purchase, the viewing user may report, to the online system 140, purchasing of one or more products to be presented in the selected candidate advertisement as well as its own identity. In an embodiment, the viewing user reports the purchase through a purchase confirmation page. In another embodiment, viewing user reports the purchase based on usage of a specific application launched by the viewing user immediately after the purchase. In yet another embodiment, reporting of the purchase is based on field agent reporting, which represents a form of non-digital reporting. In this case, the viewing user would see presentation of at least one product in an advertisement digitally delivered (e.g., through the online system 140) to the viewing user. Then, the viewing user would walk into a “brick and mortar” store and purchase (offline or in a non-digital manner) a product based on the previously seen advertisement. The viewing user would then report the offline (non-digital) purchase of the product to avoid receiving in the future retargeting advertisements related to the purchased product. Reporting of the offline purchase can be achieved through a specialized application for reporting offline purchasing of products, such as through an application provided by a merchant that sells the products. In yet another embodiment, self-reporting of purchasing a product can be achieved after viewing and exiting a retargeting advertisement presenting the product that has already been purchased by the viewing user. In this case, the viewing user reports purchasing the product after viewing the retargeting advertisement in order to block future reception of retargeting advertisements related to the same purchased product.

Responsive to determining that the viewing user performed the conversion event specified in the ad campaign, the online system 140 blocks 320 the selected candidate advertisement from being eligible for presentation to the viewing user. In an embodiment, the online system 140 blocks 320 the selected candidate advertisement prior to an auction. In this case, the online system 140 blocks 320 the selected candidate advertisement before providing the selected candidate advertisement to an advertisement selection process (auction) that selects at least one advertisement for presentation based on bids provided thereto. In another embodiment, online system 140 blocks 320 the selected candidate advertisement after the auction. In this case, the online system 140 first provides the selected candidate advertisement to an advertisement selection process that selects at least one advertisement for presentation based on bids provided thereto. For example, the content selection module 235 performs the advertisement selection process and selects at least one advertisement for presentation from a plurality of advertisements related to different ad campaigns based on bid amounts provided to the content selection module 235 by multiple advertisers. After the advertisement selection process (auction) is performed, the online system 140 blocks 320 the selected candidate advertisement from being eligible for presentation to the viewing user, wherein the at least one advertisement selected by the advertisement selection process for presentation comprises the candidate advertisement.

In some embodiments, the online system 140 selects another advertisement from the ad campaign as another candidate advertisement to present to the viewing user. After determining that the viewing user did not perform a conversion event specified in the other advertisement, the online system 140 presents the other selected candidate advertisement to the viewing user via a client device 110.

Aggregating Information about Performed Conversion Events

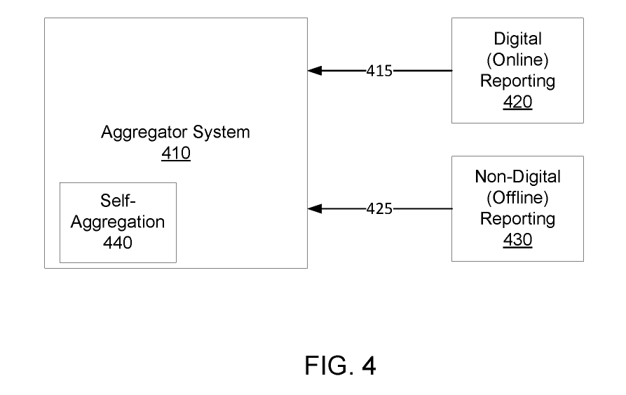

FIG. 4 illustrates a process flow diagram of different mechanisms for reporting of already performed conversion events, in accordance with an embodiment. As described above in conjunction with FIG. 3, an aggregator system 410 obtains 315 information that a viewing user of the online system 140 performed in the past a conversion event specified in an advertising campaign (“ad campaign”). As discussed above, the conversion event can be related to purchasing one or more products specified in the ad campaign, or purchasing of one or more products that are competing products to products specified in the ad campaign. In an embodiment, the aggregator system 410 is a publisher related to the online system 140. In another embodiment, the aggregator system 410 is the third party system 130 not directly related to the online system 140, such as a service related to a merchant that sells certain products advertised in one or more advertisements of the ad campaign.

In some embodiments, reporting 415 to the aggregator system 410 about purchasing one or more products is based on digital or online reporting 420. The digital reporting 420 may originate from the viewing user itself. In an embodiment, as described above in conjunction with FIG. 3, at a time of purchase, the viewing user reports 415 purchasing of a product using a purchase confirmation page on a merchant site. The reported information 415 may comprise a globally unique identifier of the purchased product and an identification of the viewing user. In another embodiment, as described above in conjunction with FIG. 3, the viewing user reports 415 purchasing of a product using a specific application launched by the viewing user immediately after purchasing the product. The application launched by the viewing user at a time of purchase may be directly provided by the aggregator system 410. Alternatively, the application launched by the viewing user at a time of purchase may be related to a merchant that sells the product. In an embodiment, the reporting 415 comprising information about the purchased product and information about the viewing user originates from the digital reporting 420 after the viewing user sees and exits a retargeting advertisement related to the product that has already been purchased by the viewing user.

In some embodiments, reporting 425 to the aggregator system 410 about purchasing one or more products is based on non-digital or offline reporting 430. In an embodiment, as described above in conjunction with FIG. 3, the non-digital reporting 430 is based on field agent reporting. After purchasing a product in a “brick and mortar” store, the viewing user may report 425 the offline (non-digital) purchase of the product to avoid receiving in the future retargeting advertisements related to the purchased product. The reported information 425 may comprise a globally unique identifier of the purchased product and an identification of the viewing user. In an embodiment, reporting 425 of the offline purchase is achieved through a specialized application for reporting offline purchasing of products, such as an application provided by a merchant that sells the products in the “brick and mortar” store.

In some embodiments, the aggregator system 410 is a publisher related to the online system 140. Then, the aggregator system 410 may obtain information about purchased products and information about online system users who have purchased the products through self-aggregation 440. The aggregator system 410 may self-aggregate 440 unique identifiers of the purchased products as well as identifiers of online system users who have purchased the products. In an embodiment, the aggregator system 410 may obtain, through the self-aggregation 440, the identifiers of the purchased products and of the online system user(s) based on tracking pixels at browser presentations of purchasing confirmation pages. In another embodiment, the aggregator system 410 obtains, through the self-aggregation 440, the identifiers of the purchased products and of the online system user(s) based on cookies related to purchasing confirmation pages. In yet another embodiment, the aggregator system 410 obtains, through the self-aggregation 440, the identifiers of the purchased products and of the online system user(s) based on the users' PIIS. In yet another embodiment, the aggregator system 410 obtains, through the self-aggregation 440, the identifiers of the purchased products and of the online system user(s) based on API interacting with presentations of purchasing confirmations on a mobile application where purchases occur. In yet another embodiment, the aggregator system 410 obtains, through the self-aggregation 440, the identifiers of the purchased products and of the online system user(s) based on browser plug-ins interacting with purchasing confirmation pages.

### Summary

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving information for an advertising campaign (“ad campaign”) including one or more advertisements for presentation to one or more users of an online system, the information specifying at least one conversion event for the one or more advertisements in the ad campaign;
selecting an advertisement from the ad campaign as a candidate advertisement to present to a viewing user of the online system;
obtaining information that the viewing user performed a conversion event specified in the ad campaign; and
responsive to determining that the viewing user performed the conversion event specified in the ad campaign, blocking the selected candidate advertisement from being eligible for presentation to the viewing user.

2. The method of claim 1, wherein the conversion event comprises:
purchasing in the past one or more products presented in the selected candidate advertisement.

3. The method of claim 1, wherein the conversion event comprises:
purchasing in the past a competing product to at least one product presented in the selected candidate advertisement.

4. The method of claim 1, wherein blocking the selected candidate advertisement from being eligible for presentation to the viewing user comprises:
blocking the selected candidate advertisement before providing the selected candidate advertisement to an advertisement selection process that selects at least one advertisement based on bids provided thereto.

5. The method of claim 1, wherein blocking the selected candidate advertisement from being eligible for presentation to the viewing user comprises:
providing the selected candidate advertisement to an advertisement selection process that selects at least one advertisement based on bids provided thereto; and
blocking the selected candidate advertisement from being eligible for presentation to the viewing user, the at least one advertisement selected by the advertisement selection process comprises the selected candidate advertisement.

6. The method of claim 1, wherein selecting the advertisement from the ad campaign as the candidate advertisement to present to the viewing user comprises:
selecting the candidate advertisement from the ad campaign based on the viewing user having seen at least a part of a content related to at least one product associated with the ad campaign.

7. The method of claim 1, wherein obtaining information that the viewing user performed the conversion event specified in the ad campaign comprises:
receiving information about an identity of the viewing user;
receiving information about the conversion event;
obtaining an identity of a user of the online system to whom an impression will be delivered for presentation of the selected candidate advertisement;
matching, at a time of the impression, the identity of the viewing user with the identity of the user of the online system; and
matching, at the time of the impression, the received information about the conversion event with information about another conversion event specified in the selected candidate advertisement.

8. The method of claim 7, wherein receiving information about the conversion event and about the identity of the viewing user comprises:
receiving, from a service system, information that the viewing user purchased one or more products presented in the selected candidate advertisement, the identity of the viewing user being aggregated by the service system.

9. The method of claim 7, wherein receiving information about the conversion event and about the identity of the viewing user comprises:
receiving information obtained based on tracking pixels at one or more browser presentations of one or more purchasing confirmations in relation to one or more products presented in the selected candidate advertisement.

10. The method of claim 7, wherein receiving information about the conversion event and about the identity of the viewing user comprises:
receiving information obtained based on one or more cookies associated with one or more publishing sites in relation to presenting one or more purchasing confirmations for one or more products presented in the selected candidate advertisement.

11. The method of claim 7, wherein receiving information about the identity of the viewing user comprises:
receiving Personally Identifiable Information (PII) related to the viewing user.

12. The method of claim 7, wherein receiving information about the conversion event and about the identity of the viewing user comprises:
receiving directly from the viewing user information about purchasing one or more products presented in the selected candidate advertisement and the identity of the viewing user.

13. The method of claim 1, further comprising:
selecting another advertisement from the ad campaign as another candidate advertisement to present to the viewing user of the online system; and
responsive to determining that the viewing user did not perform another conversion event specified in the other advertisement, presenting the other selected candidate advertisement to the viewing user via a client device.

14. A computer program product comprising a computer-readable storage medium having instructions encoded thereon that, when executed by a processor, cause the processor to:
receive information for an advertising campaign (“ad campaign”) including one or more advertisements for presentation to one or more users of an online system, the information specifying at least one conversion event for the one or more advertisements in the ad campaign;
select an advertisement from the ad campaign as a candidate advertisement to present to a viewing user of the online system;
obtain information that the viewing user performed a conversion event specified in the ad campaign; and
responsive to determination that the viewing user performed the conversion event specified in the ad campaign, block the selected candidate advertisement from being eligible for presentation to the viewing user.

15. The computer program product of claim 14, wherein block the selected candidate advertisement from being eligible for presentation to the viewing user comprises:
block the selected candidate advertisement before providing the selected candidate advertisement to an advertisement selection process that selects at least one advertisement based on bids provided thereto.

16. The computer program product of claim 14, wherein select the advertisement from the ad campaign as the candidate advertisement to present to the viewing user comprises:
selecting the candidate advertisement from the ad campaign based on the viewing user having seen at least a part of a content related to at least one product associated with the ad campaign.

17. The computer program product of claim 14, wherein obtain information that the viewing user performed the conversion event specified in the ad campaign comprises:
receive information about an identity of the viewing user;
receive information about the conversion event;
obtain an identity of a user of the online system to whom an impression will be delivered for presentation of the selected candidate advertisement;
match, at a time of the impression, the identity of the viewing user with the identity of the user of the online system; and
match, at the time of the impression, the received information about the conversion event with information about another conversion event specified in the selected candidate advertisement.

18. The computer program product of claim 17, wherein receive information about the conversion event and about the identity of the viewing user comprises:
receive, from a service system, information that the viewing user purchased one or more products presented in the selected candidate advertisement, the identity of the viewing user being aggregated by the service system.

19. The computer program product of claim 17, wherein receive information about the conversion event and about the identity of the viewing user comprises:
receive information obtained based on tracking pixels at one or more browser presentations of one or more purchasing confirmations in relation to one or more products presented in the selected candidate advertisement.

20. The computer program product of claim 17, wherein receive information about the conversion event and about the identity of the viewing user comprises:
receive information obtained based on one or more cookies associated with one or more publishing sites in relation to presenting one or more purchasing confirmations for one or more products presented in the selected candidate advertisement.
